(19) United States
(12) Patent Application Publication
(10) Pub. No.: US 2021/0313751 A1
(43) Pub. Date: Oct. 7, 2021

(54) ELECTRICAL CONNECTOR AND PLUGABLE ELECTRICAL DEVICES

(71) Applicant: ACEON INNOVATION LTD, Tefford (GB)

(72) Inventor: Avtarjeet Singh Dhanjal, Ironbridge (GB)

(21) Appl. No.: 15/095,120

(22) Filed: Apr. 10, 2016

Related U.S. Application Data
(60) Provisional application No. 62/194,544, filed on Jul. 20, 2015.

(30) Foreign Application Priority Data
Sep. 16, 2015 (GB) 1516456.9

(51) Int. Cl. H01R 31/06; H01H 71/08; H01R 4/48; H01R 13/44; H01R 13/514

(52) U.S. Cl. CPC H01R 31/065; H01H 71/08; H01R 13/514; H01R 13/44; H01R 4/4818

(57) ABSTRACT

A modular Connector with facility to terminate and connect incoming and out-going wires, eliminating any need to use pig-tails or other such arrangement, normally residing within a wall box or at other such situation; once the mains wires are connected and terminated, is designed to be finger-safe by default, can be handled, engaged and disengaged safely; and the wiring circuit may be tested at an early stage of construction; and connectible to corresponding functional device/s.

### CROSS-REFERENCE TO RELATED APPLICATIONS

This application relates to and claims the benefit of prior U.S. Provisional Application No. 62/194,544 filed Jul. 20, 2015 and GB application GB1516456.9 filed on Jul. 16, 2015, both incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The invention is related to electrical wiring and electrical functional devices and more particularly to Safety in Wiring Practices and Safety at Workplace.

### BACKGROUND OF THE INVENTION

The conventional approach for installation of electrical functional devices, such as wall sockets, switches and lights, in buildings or in other such structures, is that during the First Fix/Rough Phase of construction, an electrician installs a series of electrical wall mounting boxes and routes/installs power cables/wires through walls/partitions, leaving long tails/cables at each wall box. During the Trim Phase, the electrician returns to trim back the long ends of the cables and installs the electrical devices onto the boxes, and turns the power supply on from the main switch/s at the distribution box.

During this process building contractors or self-builders face several problems including:

With the conventional approach, wiring circuit cannot be completed till all the function devices are installed and connected which takes place only at the Trim/finish Phase of construction; nor does it allow for electrical wiring/circuits to be tested at the Rough phase of construction, when any remedial work is much easier and less costly.

With the conventional approach, the time period between the Rough Phase and the Trim Phase of the construction process may be several months, during this period several other tradesmen would also be working on site around these installations, and may come into contact with the long tails at each box. This is a potentially dangerous situation.

The safety regulations require that in and out ground wires are permanently connected to provide a continuous grounding/earthing even when only a few of outlets in a row are installed, with the conventional approach, this requirement is met by using a pig-tales or other such devices.

In the conventional approach, during the Trim Phase, when installing functional devices, the long wires/tails at each mounting box need to be trimmed back to a suitable size, often several inches at a time, creating an unnecessary waste of costly wiring material.

To repair or to replace any functional device in the conventional approach, it is absolutely mandatory to turn off the power supply some cases of the whole building or at least of the particular line/circuit where the fitting in question to replaced, which can disrupt the normal functioning of the house/building, where several equipment may need a continuous power supply.

Examples exist of approaches to improve the safety during wiring installation, for example Gorman in U.S. patent application US2012/0021623, introduced an additional module to terminate the incoming and connects outgoing wires, and the proposed module to act as an intermediary device and to serve frictionally removable functional devices. The offered solutions by Gorman have several shortcomings:

a. The intermediary module uses traditional method of wiring which involves making clock-wise hooks and securing the wiring by tightening relevant screws, the method used is not only time consuming but provides no facility for multiple wires to be terminated and connected at one point, thus one has to use another traditional system of pigtails, means additional hardware; The module disclosed by Gorman therein provides to no such facility for multiple ground wires to be terminated at one point, again relies upon pigtails;
b. The connecting module disclosed therein by Gorman is not designed to be finger-safe by default, additional removable covers are required to cover the live terminal, which can be forgotten or can break off at some stage;
c. The connecting module disclosed therein provided no provision for direct testing of the electrical circuit at an early stage without installing all of the functional devices on the circuit; the connecting module disclosed therein provided no distinction between functional devices of different voltage or different ampere.
d. Provides only a single inflexible arrangement of 4 female apertures, unsuitable for frictional connection with a range of functional devices.

### SUMMARY OF THE INVENTION

The present invention provides a finger safe electrical wiring modular connector (02) designed to normally reside behind a functional device within a wall box (04) or at other such situation; comprising a plurality of terminal bars/blocks (025), made from an electrically conducting material, held individually within a non-conducting casing/body configured to receive, terminate and connect incoming and out-going wires (03), bare/stripped ends of the wires to be held securely using one of the mechanical methods; each terminal bar/block may offer capacity to hold plurality of wires, thus eliminating any need to use pig-tails or other such arrangement;

The present invention:
a. An electrical connector (02) comprising at least two faces, each serving a different function,
   a first face comprises a plurality of terminal bars/blocks made of an electrically conductive material, each bar/block designed to connect and hold securely a number of electrical wires, serving the first function;
   a second face, having plurality of female terminals to frictionally connect to corresponding functional devices (01) serving the second function;
   all nested with an outer body or casing made from a non-conducting material;
b. Different Functional Devices (01) such as electrical wall sockets/outlets, switches and light fittings, equipped to distributing or operating electrical/electronic functions, having a connectible side configured to plug-in frictionally to the said connector (02);
c. When a functional device (01) is not designed or equipped to connect directly with the electrical connector (02), an intermediary converter (07) may be employed. and different embodiments of the connector may have different configurations to suit different functional devices (01);

### BRIEF DESCRIPTION OF THE DRAWINGS

The accompanying drawing(s), which are incorporated in and constitute a part of this specification, illustrate several aspects described below.

FIG. 01 expresses one of the variations of electrical connector (02) residing within a wall box, when plurality of wires (03) connected either from one or both ends of the modular electrical connector (02), expressing Type G Sockets/outlets (01) and is consistent with the present invention.

FIG. 02. Expresses one of the variations of electrical connector (02) residing within a wall box, when plurality of wires (03) may be connected either from one or both ends of the modular electrical connector (02), expressing Type E Sockets/outlets (01) and is consistent with the present invention.

FIG. 03. Expresses one of the variations of electrical connector (02) residing within a wall box, when plurality of wires (03) may be connected either from one or both ends of the modular electrical connector (02), expressing Type F Sockets/outlets (01) or is consistent with the present invention.

FIG. 04. Expresses one of the variations of electrical connector (02) residing within a wall box, when plurality of wires (03) may be connected either from one or both ends of the modular electrical connector (02), expressing Type B Sockets/outlets (01) or is consistent with the present invention.

FIG. 05-06 expresses one of the variations of electrical connector (02) expressing its internal connections arrangement, designed to work with Type G Sockets/Outlets (01) and is consistent with the present invention.

FIG. 07-08 expresses one of the variations of electrical connector (02) expressing its internal connections arrangement, designed to work with Type B Sockets/Outlets (01) and is consistent with the present invention.

FIG. 09 and FIG. 10 expresses one of the variations of electrical connector (02) expressing its internal connections arrangement, designed to work with Type B Sockets/Outlets (01) special NEMA Receptacle for 250V-20 amp, and is consistent with the present invention.

FIG. 11 expresses one of the variations of electrical connector (02) expressing its internal connections arrangement, designed to work with electrical switch to serve 2, 3, 4 way and dimmer switches providing additional wiring connections; and is consistent with the present invention.

FIG. 12 expresses one of the variations of electrical connector (02) designed to work with Type I Sockets/Outlets (01) and is consistent with the present invention.

FIG. 13 and FIG. 14 expresses the interface between one embodiment of the modular electrical connector (02) and a functional Device of Type-G Receptacles, is consistent with the present invention.

FIG. 14 expresses the interface between one embodiment of the modular electrical connector (02) and a functional Device of Type-G Receptacle, where connector is shown without its casing/body (028) expressing internal female elements (026) and connecting bars (025) on one side and 3 males prong (016) on the other which are part of the functional device, is consistent with the present invention.

FIGS. 15, 16 & 17 expresses the plug-in interface between the modular connector (02) and a functional device (01), in three stages of coupling/interface; designed to plug in frictionally using a plurality of male prongs (016) to connect the two mechanically and electrically and it also expresses the simple locking arrangement (0181) to hold the modular electrical connector (01) and the Functional Device (02) engaged when no cradle (05) is used.

FIG. 18 expresses an optional cradle (05) that may hold the modular electrical connector (02) at a preferred location within the wall-box, for a functional device (01) to plug in frictionally and provides a stable electrical connection.

FIG. 19-20-21 introduces an embodiment of the secondary Converter Module (07) designed to convert a standard NEMA Receptacle (01), which does not have the built in male prongs (016) so it may connect with the modular Connector.

FIG. 22: shows views of standard world plug types that can be mated with the modular electrical connector of the present invention.

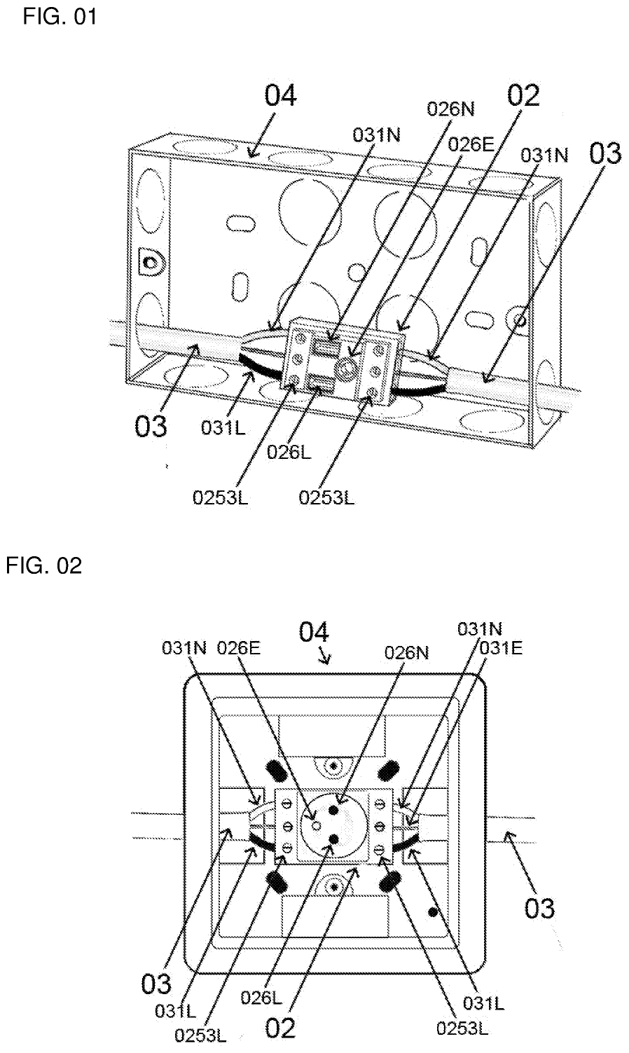

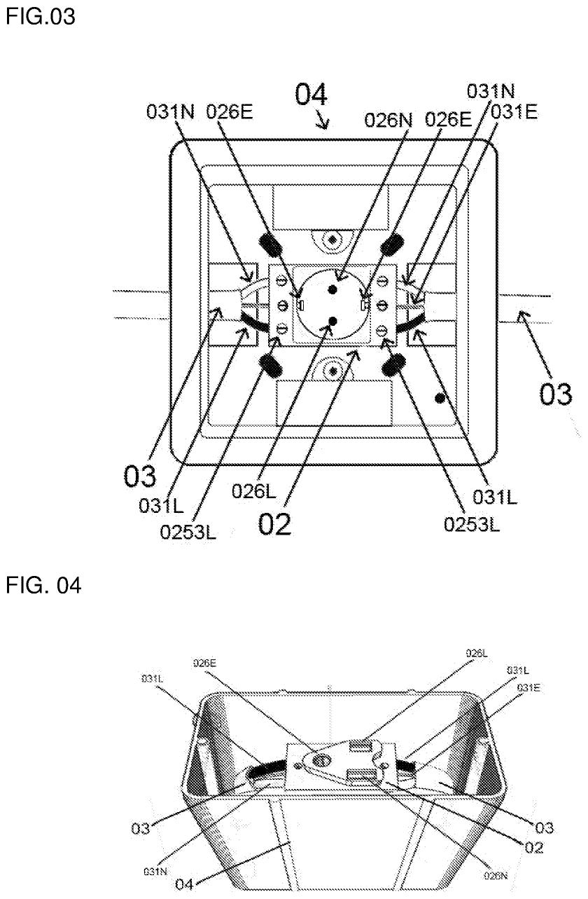

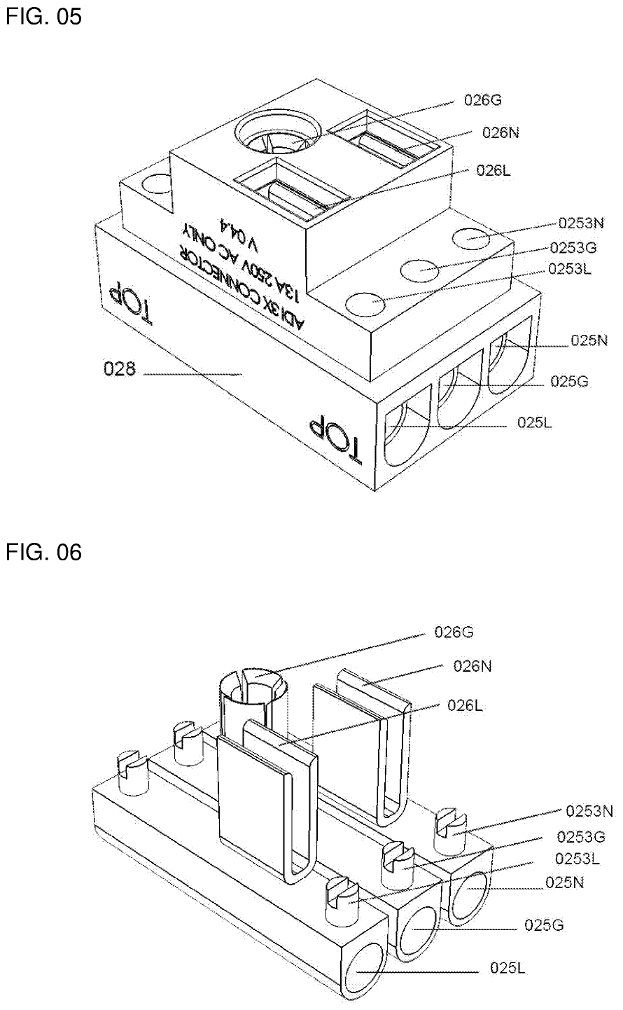

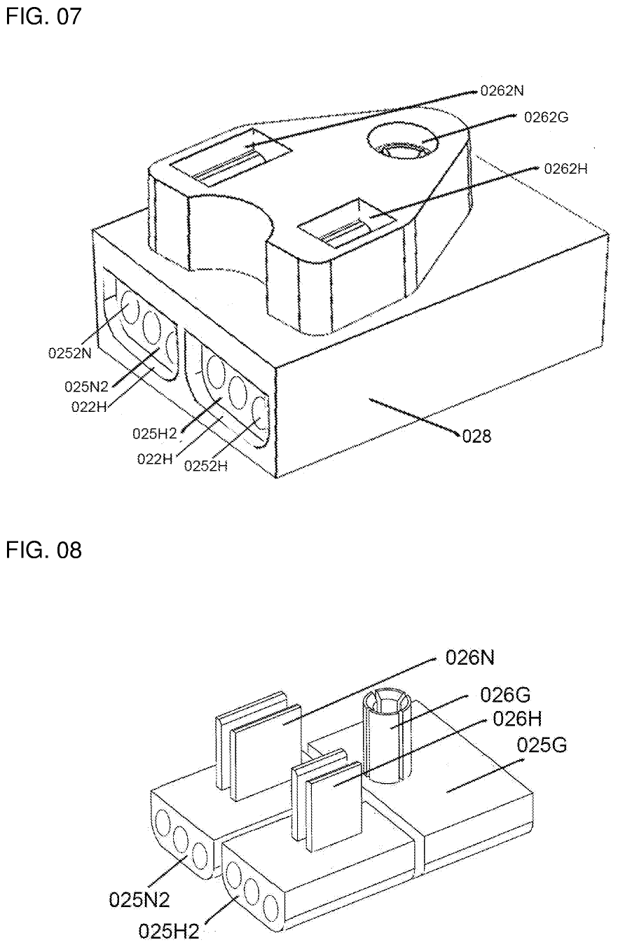

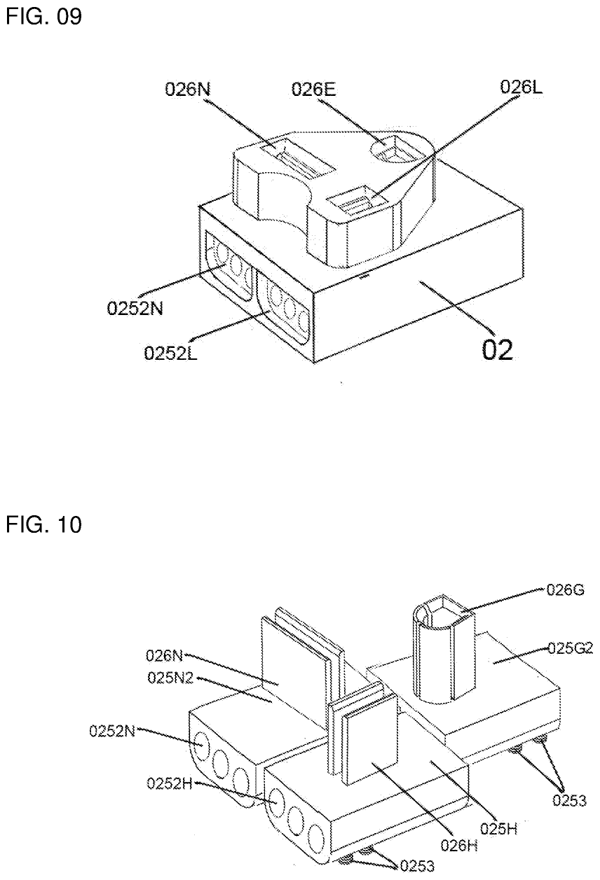

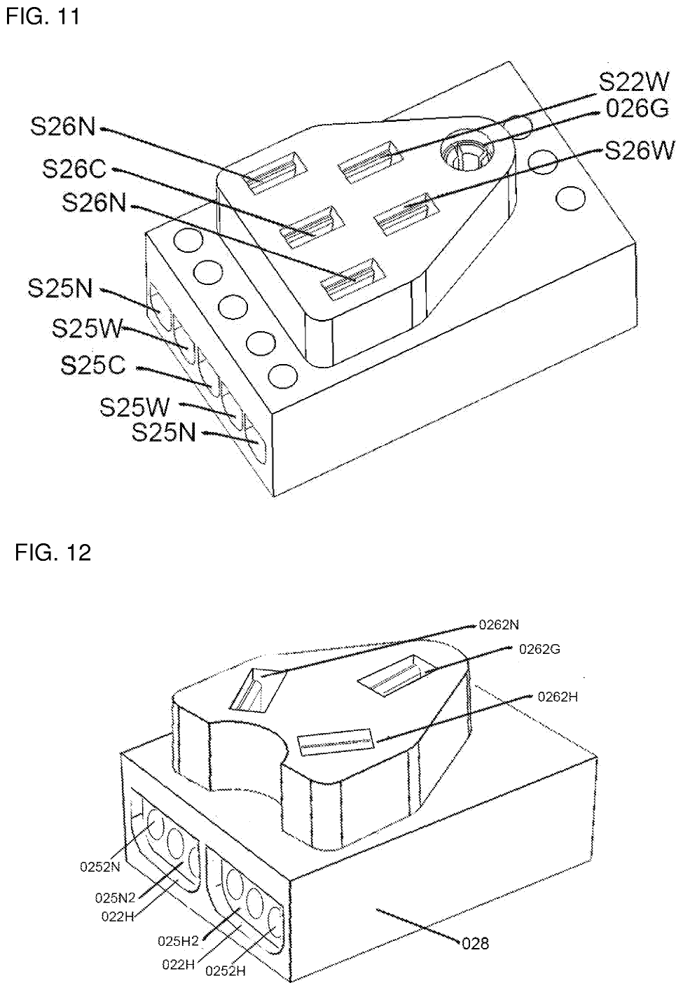

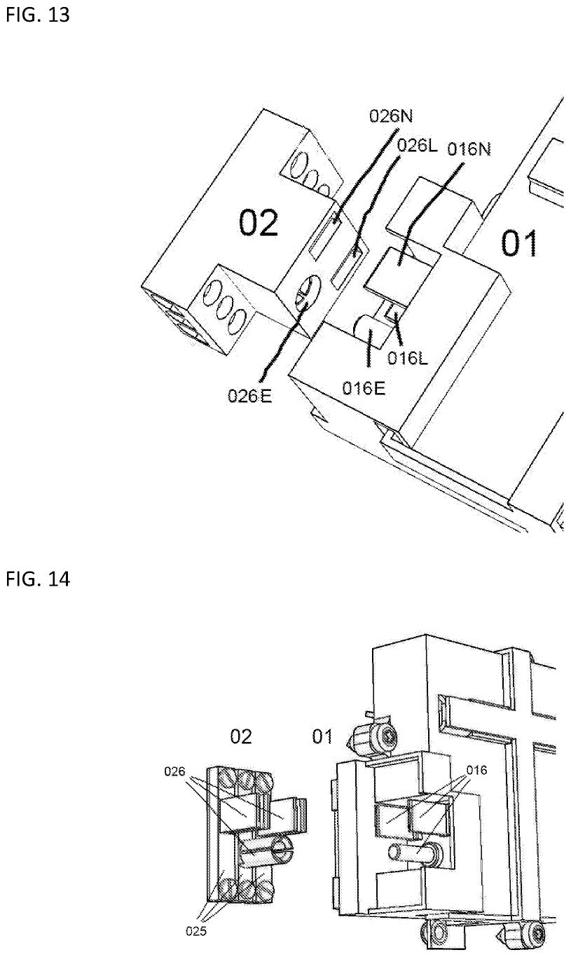

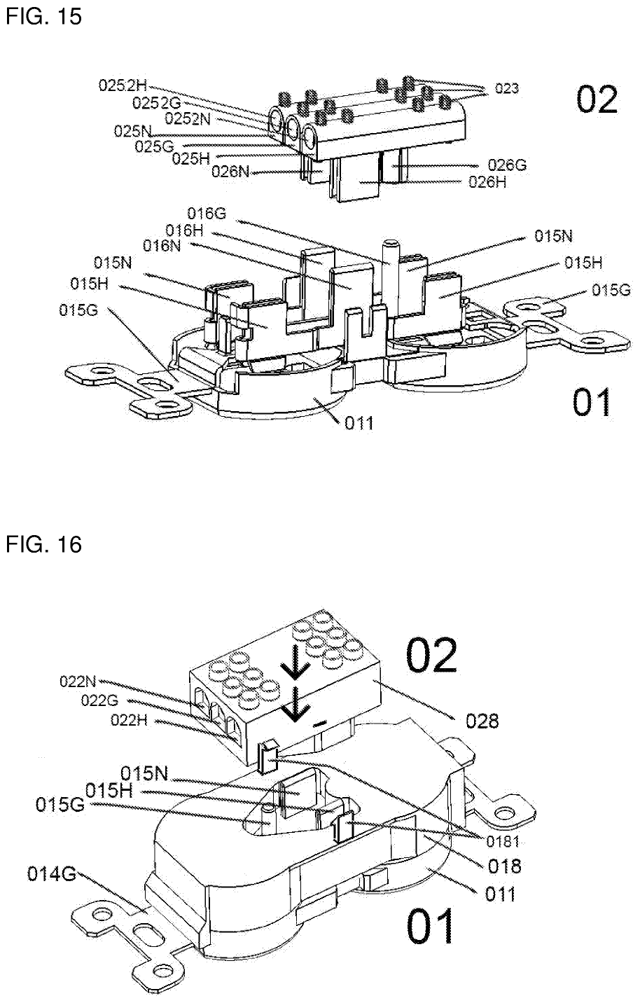

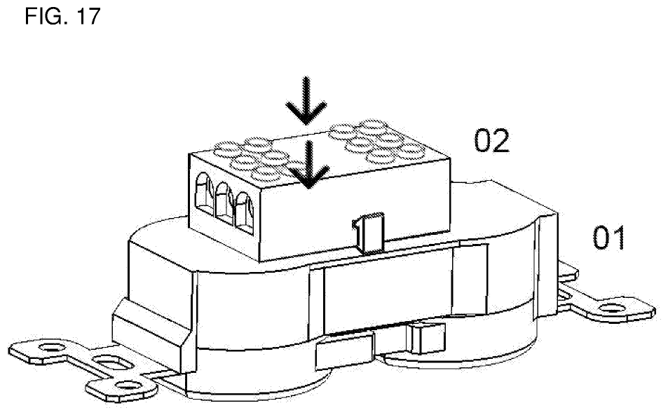

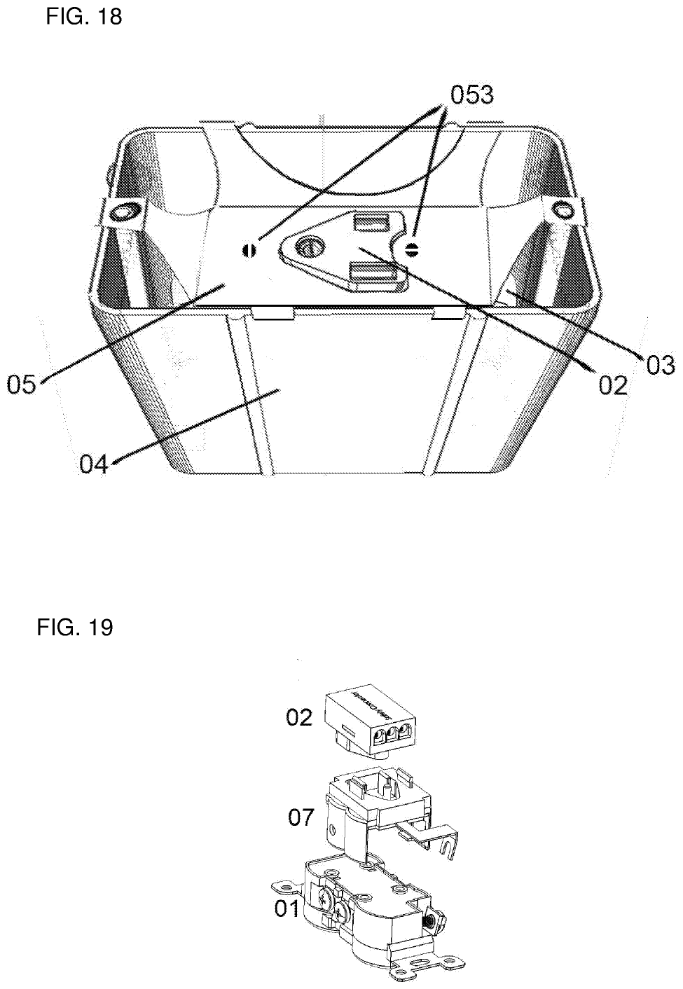

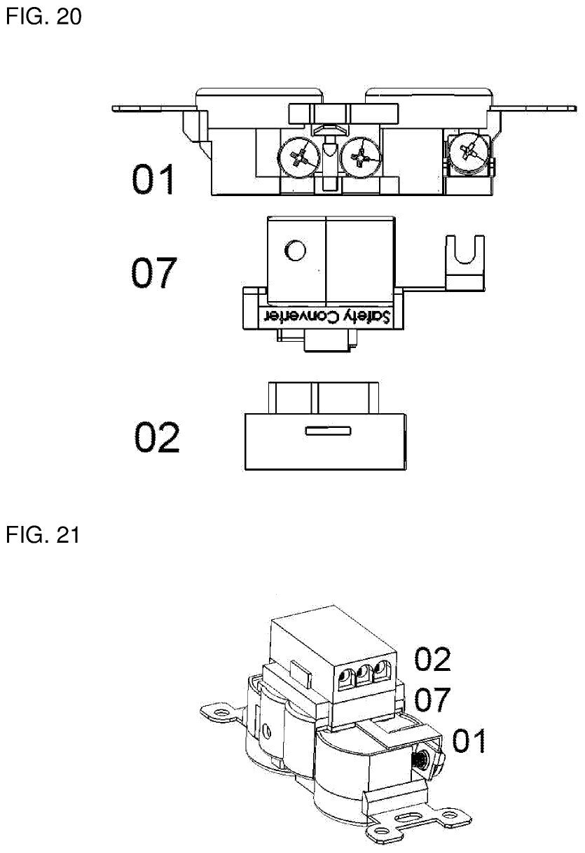

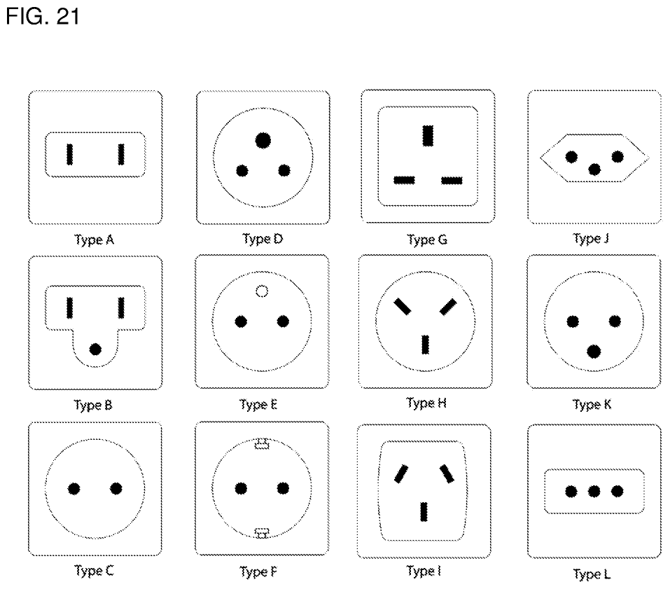

Further description of the individual elements, consistent with the present invention, for each figure is provided below:
01 Functional Device
   011 Fascia
   012 Apertures in the Fascia
   013 Screw/s on the fascia
   014
   015 Electrically Conducting Buses (N, G, & H for Neutral, Ground & Hot)
   016 Male prongs (N, G, & H for Neutral, Ground & Hot)
   017
   018 Casing/body
   0181 Locking arrangement
02 modular Connector
   021
   022 Channels in the casing to hold terminal bars/blocks
   023
   024
   025 Terminal Bars/Blocks
   0252 Channels in the Bars/Blocks
   0253 Screws in the Bars/Blocks to hold the wires
   026 Connecting elements (N, G, & H for Neutral, Ground & Hot)
   0262 Apertures in the Connecting Elements
03 Mains Wire
   031 Individual wires (N, G, & H for Neutral, Ground & Hot)
04 Wall Box
05 Cradle to hold the modular electrical connector in the Box
09 Standard 3 pin plug

### DETAILED DESCRIPTION OF THE PREFERRED EMBODIMENTS

It is to be understood that this invention is not limited to particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience and disclosure found in any section may be combined with that in another section. Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context clearly dictates otherwise

### I. Definitions

Unless defined otherwise, all technical and scientific terms used herein have the same meaning as commonly understood by one of ordinary skill in the art to which this invention belongs. As used herein the following terms have the following meanings.

“Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a device consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

The modular Connector once connected to the mains wires, is designed to be finger-safe by default, by keeping each terminal bar/block recessed than the casing/body at each end, creating a safe overhang of the non-conducting casing/body thus preventing the possibility of touching the live parts when touched or handled by bare hands in normal circumstances;

The modular Connector (02) possesses a socket with a set of mating apertures (022), thus providing an interface with a functional device. Suitable functional devices include those disclosed in UK patent GB2505930 to Dhanjal. Each aperture holding a tubular/female element (026) is constructed from an electrically conducting material. One end of tubular/female elements (026) is configured to butt contact with the terminal blocks (025) and the other end configured to receive corresponding male prongs of a functional device and to connect electrically.

The modular Connector (02) once connected to the mains wires (03), offers an opportunity to complete and to test the wiring circuit at an early stage of construction;

Functional Devices (01) such as receptacles, switches, light-fittings or others, suitable for distributing or operating electrical/electronic functions, having a user side and the connectible side configured to plug-in frictionally and connect to communicate/transfer electrical, electronic signals between a device and the connector of the present invention may be handled, connected and disconnected from the functional device while the power supply is switched on.

Different embodiments of the connector of the present invention may have different configurations to receive/connect with different functional devices (01) such as receptacles, switches and others; and may also be configured for different electrical potential (volts & AMPs) or other criteria;

For example one embodiment of the connector of the present invention designed to receive a standard 125V 5-15 AMPs wall receptacle may have specifications and configuration of its female apertures identically to the user side of the receptacle; similarly one embodiment of the connector is configured to receive a wall receptacle for 250V, may comprise specifications and configuration of its female apertures identically to the user side of the receptacle

Another embodiment of the connector is configured to connect with a 3 way or 4 way switches may have additional terminal bars/blocks providing connection opportunity for additional wiring connections.

In another embodiment the connector may have different configurations to receive/connect with functional devices (01) of different configuration those vary from country to country or of different power potential, or performing different functions or other such criteria;

In another embodiment the connector when placed/installed within a wall box, may need an optional cradle to hold it at a preferred location or in a preferred position within the wall box, as different wall boxes may be of a different sizes or different configurations; thus such cradle may be of different configuration or made of different materials as the need may be, or it may be built into a wall box;

In another embodiment the modular Connector when placed/installed within a wall box may need a simple locking arrangement to hold the modular Connector and the Functional Device engaged until unlocked deliberately for disengagement of the two.

Where a functional device is not equipped or designed to receive a modular Connector directly, may need an optional Extension Module, different embodiments of the Extension Module not only provide mechanism to physical and electrically engage with the modular Connector, may also make the device finger safe, but connectible/pluggable when the modular Connector is live and power is switched on.

One aspect of the invention deals with the connections arrangement from the mains supply wires to the functional devices, and does not affect or cover the functional side of devices which may be subject to local regulatory requirements.

Features and advantage of the invention will be expressed by example, but not limited to: a modular electrical wiring connector (02) is an additional device introduced to (a) facilitate the termination of all wiring entering a wall box (b) and connect all out-going wires on one side and (c) to provide a facility to plug-in and connect one of the range of functional devices, (d) it also serves the functions of pigtails used where multiple wires to be held/connected together securely and (e) is designed to normally reside within a wall box (04) or at other such situation;

To serve above functions it comprises a plurality of terminal bars/blocks (025), made from an electrically conducting material, held individually within a non-conducting casing/body (028) and is configured to receive, terminate and connect incoming and out-going wires (03), bare/stripped ends of the mains wires (03) to be held securely using one of the mechanical methods; each terminal bar/block (025) to hold plurality of wires (03), thus eliminating any need to use pig-tails of other such arrangement.

An embodiment of the modular electrical wiring connector (02) comprising a plurality of terminal bars/blocks (025), each bar/block (025) comprising plurality of channels (0252) to connect the mains wires (03), these wires (03) may be held securely within the channels (0252) using one of more of the mechanical methods for example wired held securely using screws (0253) or suing a spring mechanism or any other such means;

An embodiment of the modular electrical wiring Connector (02) once connected to the mains wires (03), is designed to be finger-safe by default, by keeping each terminal bar/block (025) shorter than the casing/body (028) at each end, thus creating a safe overhang of the non-conducting casing/body (028) and preventing the possibility of touching any live parts when handled by bare hands in normal circumstances;

The modular Connector (02) once connected to the mains wires (03), offers an opportunity to complete and to test the wiring circuit at an early stage of construction;

The modular connector (02) also comprises a set of mating apertures (022) present on the first face of the outer casing/body, this provides an interface with the corresponding functional device/s. Each aperture holding a tubular/female element (026) made from an electrically conducting material, one end of tubular/female elements (026) designed to butt contact with corresponding terminal block (025) and the other end designed to receive corresponding male prongs of a functional device and to connect electrically.

Corresponding Functional Devices (01) such as receptacles, switches, light-fittings or others, suitable for distributing or operating electrical/electronic functions, having a user side, (not covered or affected by this patent); and the connectible side configured to plug-in frictionally and connect to communicate/transfer electrical, electronic signals between a device and the modular electrical wiring Connector (02) and can be handled, connected and disconnected while the power supply remains switched on.

Different embodiments of the modular electrical wiring connector may have different configurations to receive/connect with different functional devices (01) such as receptacles, switches and others; and may also be configured for different electrical potential (volts & AMPs) or other such criteria.

For example one embodiment of the modular Connector designed to receive a standard 125V 5-15 AMPs wall receptacle may have specifications and configuration of its female apertures identically to the user side of the receptacle; similarly one embodiment of the modular Connector designed to receive a wall receptacle for 250V, may comprise specifications and configuration of its female apertures identically to the user side of the receptacle and this arrangement may follow on when used with functional devices of different configuration those vary from situations to situations and from country to country.

One embodiment of the modular electrical Connector designed to connect with a 3 way or 4 way switches may have additional terminal bars/blocks providing connection opportunity for additional wiring connections.

In another embodiment the modular electrical Connector may have different configurations to receive/connect with functional devices (01) of different configuration those vary from country to country or of different power potential, or performing different functions or other such criteria;

In another embodiment the modular electrical Connector when placed/installed within a wall box, may need an optional cradle to hold it at a preferred location or in a preferred position within the wall box, as different wall boxes may be of a different sizes or different configurations; thus such cradle may be of different configuration or made of different materials as the need may be, or it may be built into a wall box;

In another embodiment the modular electrical Connector when placed/installed within a wall box may need a simple locking arrangement to hold the modular electrical Connector and the Functional Device engaged until unlocked deliberately for disengagement of the two.

Where a functional device is not equipped or designed to receive a modular Connector directly, may need an optional Extension Module, different embodiments of the Extension Module not only provide mechanism to physical and electrically engage with the modular Connector, may also make the device finger safe, but connectible/pluggable when the modular Connector is live and power is switched on.

The present invention provides advantages a finger safe electrical connector which does not require secondary connections, such as pigtails, but can be directly connected to the mains wires and can be frictionally connected to a wide range of functional devices.

1. Electrical connector (02) comprising two faces, each serving a different function:
a first face, having plurality of channels, each designed to receiving and holding securely plurality of incoming and out-going wires (03), and
a second face, having plurality of female terminals to frictionally connect to corresponding functional devices (01);
different Functional Devices (01) equipped to distributing or operating electrical/electronic functions, having a connectible side configured to plug-in frictionally to the said electrical connector (02);
where a functional device (01) is not designed or equipped to connect directly with the electrical connector (02), an intermediary converter (07) may be employed and different embodiments of the Connector may have different configurations to suit different functional devices (01).

2. According to claim 01, the connector (02) configured to receive, terminate and connect incoming and out-going wires (03), using a plurality of terminal bars/blocks (025), made from an electrically conducting material, held individually within a non-conducting casing/body (028);

3. According to the previous claim, the connector (02) comprising a plurality of terminal bars/blocks (025), made from an electrically conducting material, each bar/block (025); comprising plurality of apertures (0252) to receive and hold bare ends of mains wires (03) securely within the apertures (0252) using one or more methods, i.e. using screws (0253) or a spring mechanism or any other such means to hold the bare ends of the wires (03) or using penetrating screws/pins through the layer of insulation to connect electrically

4. According to claim 01, the connector (02), comprises a plurality of terminal bars/blocks (025), made of an electrically conducting material, held individually within a casing/body (028), each bar/block (025) comprising plurality of apertures (0252) to receive, hold and terminate all incoming and outgoing wires (03), eliminating any need for pig-tales or other such arrangement;

5. According to claim 01, an electrical connector (02) connectible to the mains wires (03), once connected offering an opportunity to complete and to test the wiring circuit at an early stage of building construction;

6. According to claim 01, an electrical connector (02) connectible to the mains wires (03), once all the wires (03) connected and terminated, is finger-safe by default, by keeping each terminal bar/block recessed from the edges of the casing/body, creating a safe overhang of the casing/body thus preventing any possibility of touching the live parts when touched or handled by bare hands in normal circumstances;

7. According to claim 01, an electrical connector (02) connectible to different functional devices, via a set of mating apertures (022), each aperture holding a tubular/female component (026) made from an electrically conducting material, one end of each component (026) held in contact with corresponding terminal block (025) and the other end designed to receive corresponding male prongs of a functional device and to connect electrically.

8. According to claim 01, different embodiments of the connector (02) connectible mechanically and electrically to different functional devices, via a set of female apertures (022) and corresponding male prongs of the functional device/s,

9. According to previous claim, different embodiments of the connector (02) may have different configurations for receiving/connecting with different functional devices (01); and may also be configured for different electrical potentials (volts & AMPs) or other criteria;

10. According to previous claims different embodiments of the connector (02) may have different configurations to receive/connect with functional devices (01) of different configuration those vary functions device to functional device and from country to country or of different power potential, or performing different functions or other such criteria;

11. According to claim 1, the connector (02) designed to normally reside within a wall box (04) or at other such situation, and to receive and connect/mate electrically and mechanically with a functional device; to make this union practically successful and stable, the connector (02) may need to be held/restrained at a preferred location or in a preferred position using a cradle or such module, made of a suitable material and of suitable configuration as necessary, or may be built into a wall box;

12. According to claim 01, different embodiments of Functional Devices (01) such as receptacles, switches, light-fittings or others, suitable for distributing or operating electrical/electronic functions, having a user side, and the connectible side configured to plug-in/connect and to transfer electrical/electronic signals between the functional device and the connector (02), may be connected and disconnected from the Connector while the power supply is switched on and both the Functional Devices and the connector (02) are designed to be finger safe in normal circumstances.

13. According to previous claim, different embodiments of Functional Devices (01) having a connectible side configured to plug-into the connector (02), and may need a simple locking arrangement to hold the connector (02) and the Functional Device engaged until unlocked deliberately.

14. According to claim 01, different embodiments of Functional Devices (01) suitable for distributing or operating electrical/electronic functions, where a functional device is not equipped or designed to connect/mate with an electrical connector directly, may need an optional Extension Module (07), different embodiments of the Extension Module not only provide mechanism to physical and electrically engage with the connector (02), may also to make the device finger safe, and to make it connectible/pluggable to the connector (02).
